(19) United States
(12) Patent Application Publication
(10) Pub. No.: US 2026/0092893 A1
(43) Pub. Date: Apr. 2, 2026

(54) CORROSION SENSING USING A FIBER OPTIC SYSTEM FOR MAGNETIC FIELD DETECTION

(71) Applicant: The United States of America, as represented by the Secretary of the Navy, Crane, IN (US)

(72) Inventor: Armen Kvryan, Glendale, CA (US)

(73) Assignee: The United States of America, as represented by the Secretary of the Navy, Arlington, VA (US)

(21) Appl. No.: 19/343,506

(22) Filed: Sep. 29, 2025

Related U.S. Application Data
(60) Provisional application No. 63/701,096, filed on Sep. 30, 2024.

(51) Int. Cl. G01N 27/72

(52) U.S. Cl. CPC G01N 27/72

(57) ABSTRACT

Provided are apparatus and methods for detection of corrosion in materials. The apparatus and methods use at least one fiber optic cable disposed on or near the material, where the fiber optic cable includes magnetic materials doped or disposed on or within the fiber. A light source or equivalent signal generator is then used to introduce one or more signals into the fiber optic cable. Furthermore, a signal receiver/analyzer is used to receive the one or more signals after transmission through the fiber optic cable and correlate changes in the one or more signals resultant from magnetic field changes in the material due to corrosion to the degradation or corrosion of the material.

### CROSS-REFERENCE TO RELATED APPLICATIONS

The present application claims priority to and the benefit of U.S. Provisional Patent Application Serial No. 63/701,096 filed September 30, 2024, and entitled “CORROSION SENSING USING A FIBER OPTIC SYSTEM FOR MAGNETIC FIELD DETECTION,” the disclosure of which is expressly incorporated by reference herein.

### STATEMENT REGARDING FEDERALLY SPONSORED RESEARCH OR DEVELOPMENT

The innovations described herein were made in the performance of official duties by employees of the Department of the Navy and may be manufactured, used and licensed by or for the United States Government for any governmental purpose without payment of any royalties thereon. This invention (Navy Case 212237US02) is assigned to the United States Government and is available for licensing for commercial purposes. Licensing and technical inquiries may be directed to the Technology Transfer Office, Naval Surface Warfare Center Port Hueneme Division, email: Alan.w.jaeger@navy.mil or phone (805) 205-0638.

### FIELD

The present disclosure generally relates to sensing or detecting corrosion of a material, and more particularly to sensing corrosion using a fiber optic system disposed or placed on the material and detecting changes in a magnetic field (e.g., a magnetic field within the material) by examining changes in the fiber optic system affected by the magnetic field to thereby sense or detect corrosion of the material.

### BACKGROUND

Corrosion is a factor that affects almost every industry. In particular, corrosion is presently one of the biggest concerns for an aging Navy and the Department of Defense as a whole. As the current naval fleet is continually pushed to increase its service life, corrosion begins to play an even more important role in overall capability. Accordingly, early detection of corrosion of materials used in ships, or any other corrosion across a vast number of parts or components used in any of a wide variety of industries is valuable and mitigates future costs and/or may prevent failures.

In general, corrosion is difficult to detect. In the past, the techniques that had the highest rates of success included visual observation, which is time consuming and labor intensive. Aside from this, other techniques have been shown to be unreliable. Recently, sensors have been developed to detect corrosion but are difficult to implement and/or exhibit a lack of reliability and consistency. Moreover, corrosion mitigation, and more importantly, corrosion repair, typically requires the use of very harsh chemicals. Some of these chemicals have recently been banned by the EPA, which is currently a big issue for the corrosion community.

Accordingly, there is a need for improved corrosion detection methods, apparatus, and/or systems that may significantly reduce maintenance schedules/timeliness, as well as reduce the amount of harsh chemicals needed for mitigation/repair resulting from earlier detection, thus reducing the environmental impact.

### SUMMARY

The presently disclosure relates to methods, apparatus, and/or systems for corrosion detection. In particular, the present disclosure provides using a fiber optic sensing system to detect corrosion and/or any form of materials degradation by using magnetism and its effects. Some parameters that are utilized include magnetism direction, magnitude, and variance in polarity. This, in turn, provides information about the surface chemistry of the material and, more importantly, can indicate a change in the surface and matrix of the internal material. One such correlation could be oxide growth with corrosion.

According to one aspect, an apparatus for corrosion detection of a material is disclosed. The apparatus includes at least one fiber optic cable disposed on or near the material (i.e., material under test). Additionally, the apparatus includes a signal generator coupled to the at least one fiber optic cable and configured to introduce one or more signals into the fiber optic cable. Furthermore, the apparatus includes a signal receiver/analyzer configured to receive the one or more signals after transmission through the fiber optic cable and determine changes in the one or more signals occurring due to magnetic field changes in the material as a result of corrosion of the material.

According to another aspect, a method for corrosion detection of a material under test is disclosed. The method includes introducing one or more signals into a fiber optic cable disposed on the material under test and then receiving the one or more signals after transmission through the fiber optic cable, such as with a signal receiver/analyzer. Additionally, the method includes determining changes in the one or more signals occurring due to magnetic field changes in the material as a result of corrosion of the material correlating changes in the one or more signals resultant from magnetic field changes in the material.

Additional features and advantages of the presently disclosed apparatus and methods will become apparent to those skilled in the art upon consideration of the following detailed description of the illustrative embodiments.

### BRIEF DESCRIPTION OF THE DRAWINGS

FIG. 1 illustrates an example of an apparatus for detecting corrosion of a material under test using a fiber optic disposed on the material according to certain aspects of the present disclosure.

FIG. 2 illustrates one example of at least a portion of the apparatus of FIG. 1 after the material under test has suffered corrosion and magnetic fields have changed according to certain aspects of the present disclosure.

FIG. 3 illustrates another example of at least a portion of the apparatus of FIG. 1 after the material under test has suffered corrosion and magnetic fields have changed according to certain aspects of the present disclosure.

FIG. 4 illustrates a system diagram of modules/processes used for introducing and processing signals, such as optical signals, through the fiber optic for detection of changes due to magnetic field changes according to certain aspects of the present disclosure.

FIG. 5 illustrates a flow diagram of an exemplary method for detection of corrosion according to certain aspects of the present disclosure.

FIG. 6 illustrates a diagram of a corrosion detection system setup for detection of corrosion according to certain aspects of the present disclosure.

FIG. 7 illustrates a diagram of another corrosion detection system setup for detection of corrosion according to certain aspects of the present disclosure.

### DETAILED DESCRIPTION

The disclosed examples and embodiments described herein are not intended to be exhaustive or to limit the disclosure to the precise forms disclosed. Rather, the examples and embodiments selected for description have been chosen to enable one skilled in the art to practice the disclosed methods and apparatus.

The present disclosure utilizes the magnetic force interaction between either a magnetic field inherent to the material under test or, alternatively, with an external source of a magnetic field introduced through/induced within the material, and at least one fiber optic cable or fiber disposed on or near the material under test. The changes in the magnetic field that result from degradation or corrosion of the material will, in turn, affect the fiber optic, thereby allowing earlier detection of degradation or corrosion by examining signaling through the fiber optic. In further aspects, the fiber optic may include or be doped with a magnetic material that will be attracted or repulsed by the magnetic material under test to thereby cause changes or displacement in the fiber that is detectable by examining the signaling transmitted through the fiber. Still further, the particular nature of the signaling changes may be correlated to the degree and/or type of corrosion occurring in the material under test.

In further detail, it is noted that the principle of operation is based on magnetic attraction or repulsion, which further may be dependent on magnetic polarity and/or location of the magnetic materials. In particular, if the material under test is a metal including materials that possess ferromagnetism, paramagnetism, diamagnetism, and/or antiferromagnetism properties. Corrosion is detected by examining signal changes in the fiber optic that arise from displacement of the fiber.

In yet further aspects, the presently disclosed apparatus and methods employ the use of a magnetic doping material within the fiber or on the outer surface of the fiber, or both. In some aspects, it is noted that the doping preferably does not affect light transmission, or at least has minimal effects. Moreover, it is noted that fiber may include one or more fiber Bragg gratings (FBGs) that reflect particular frequencies of the optical signals transmitted in the fiber, which in turn allow for detection of signaling changes due to displacement of the fiber.

Moreover, it is noted that presently disclosed methods and apparatus employ nodes (e.g., 106 as will be discussed below), which are placed to help coordinate where an attack or change in light transmission occurs so that it can be co-located with a particular known location.

As discussed before, corrosion is currently one of the highest concerns for an aging Navy and the Department of Defense as a whole. As the current fleet is continually pushed to have higher service life, corrosion more immediately affects the Navy’s overall capability. Moreover, as materials are pushed to their extremes to achieve better or longer performance, corrosion performance and/or mitigation are typically sacrificed in pursuit of such goals.

To mitigate these problems, the present disclosure provides for corrosion detection/monitoring of materials through the use of a fiber optic sensing system that is used to detect corrosion and/or other forms of material degradation by using magnetism and its effects. The fiber optic is located near or disposed on a material to be monitored for corrosion. Changes in the magnetic field of the material resulting from corrosion may be detected due to effects of the magnetic field on the fiber optic, which in turn may be monitored to sense or detect changes in optical signaling introduced into the fiber resultant from the changed magnetic field. Accordingly, the present systems, apparatus, and methods provide for improved corrosion detection as will be described herein.

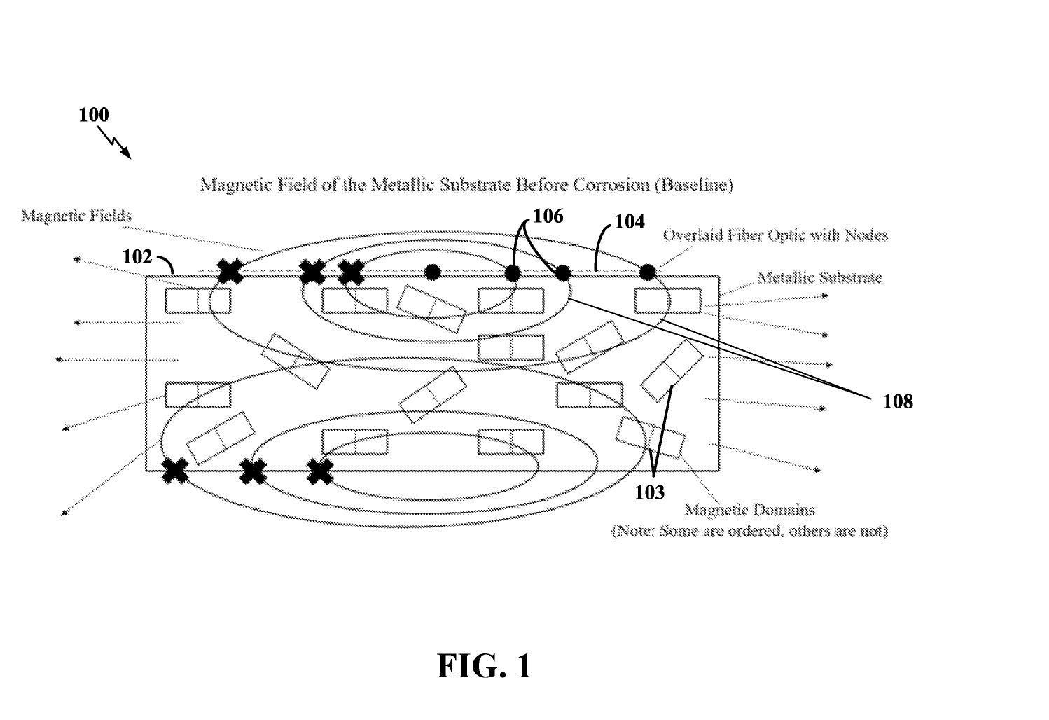

FIG. 1 illustrates an example of an apparatus/setup 100 for detecting corrosion of a material under test using a fiber optic disposed on the material according to certain aspects of the present disclosure. As shown, a material under test or metallic substrate or asset 102 inherently will contain various magnetic domains, where some may be ordered and others are not ordered as may be seen by various dipoles/domains 103. The corrosion detection apparatus or system includes a fiber optic cable or system 104 that is placed or disposed on the asset 102 that may be susceptible to degradation. The Fiber optic 104 may include one or more various nodes 106 that serve to affix the fiber optic 104 to the substrate 102. In an alternative, the system 100 may include a proxy substrate (not shown) made of magnetic materials, wherein the proxy substrate would be attached to either a material under test having magnetic characteristics, or alternatively attached to or disposed on a non-magnetic material where corrosion or change of the magnetic proxy material may be used to detect and correlate corrosion of the non-magnetic material based on the fiber optic placed on the proxy substrate or, yet further alternatively, disposed on or in contact with both the proxy substrate and the non-magnetic substrate/material that is actually under test.

The various magnetic domains 103 engender a magnetic field (e.g., measured or expressible as magnetic flux density B or magnetic field strength H) illustrated by magnetic field lines 108 in FIG. 1, which show location and intensity (i.e., larger ovals and more ovals indicate stronger fields and less indicate weaker fields). The fiber optic 104 is then used to detect any corrosion that occurs at or near the fiber by detecting a change in magnetic field strength/magnitude or polarity of the magnetic field that results from or occurs due to such corrosion.

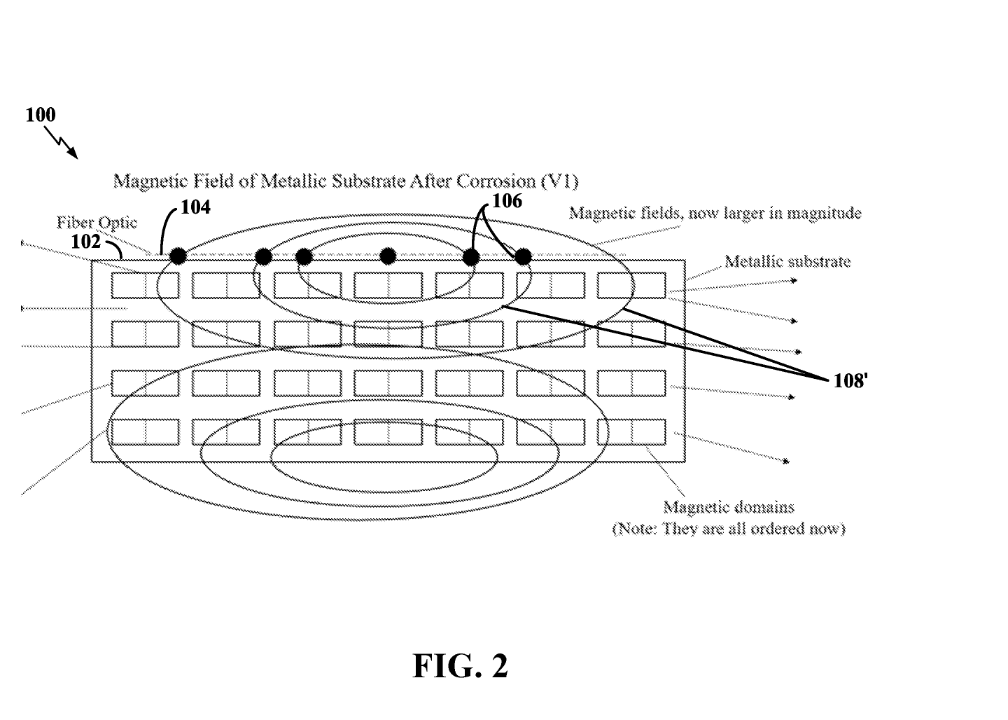

FIG. 2 illustrates one example of the apparatus/setup 100 of FIG. 1 after the material under test has suffered corrosion and magnetic fields have changed according to certain aspects of the present disclosure. As may be seen in this particular example, the magnetic domains are more ordered than FIG. 1 as a result of a particular type of corrosion, and these more ordered domains engender a larger/stronger magnetic field represented by 108′. This changed magnetic field acts upon the fiber 102 such that signaling introduced into the fiber 102 will change, which can then be detected by an optical signal receiver or equivalent apparatus/device.

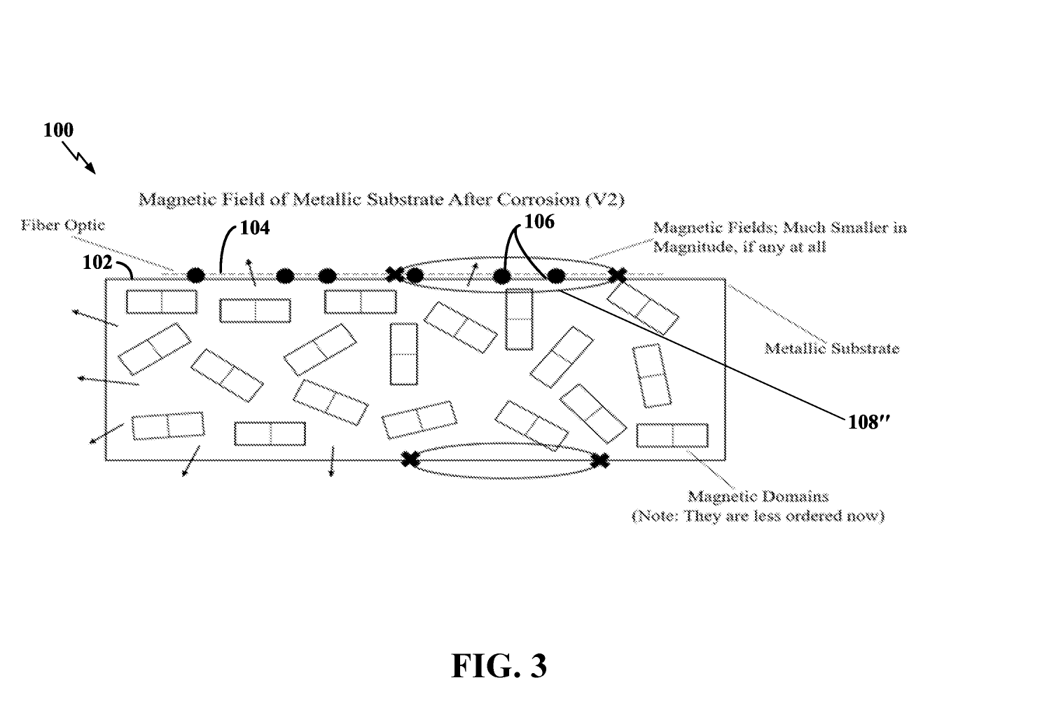

FIG. 3 illustrates another example of the apparatus/setup 100 after the material under test has suffered corrosion and magnetic fields have changed according to certain aspects of the present disclosure. As may be seen in this particular example, the magnetic domains are less ordered than FIG. 1 as a result of another particular type of corrosion, and these less ordered domains engender a lesser/weaker magnetic field represented by 108′′. This changed magnetic field acts upon the fiber 102 such that signaling introduced into the fiber 102 will change, which can then be detected by an optical signal receiver or equivalent apparatus/device.

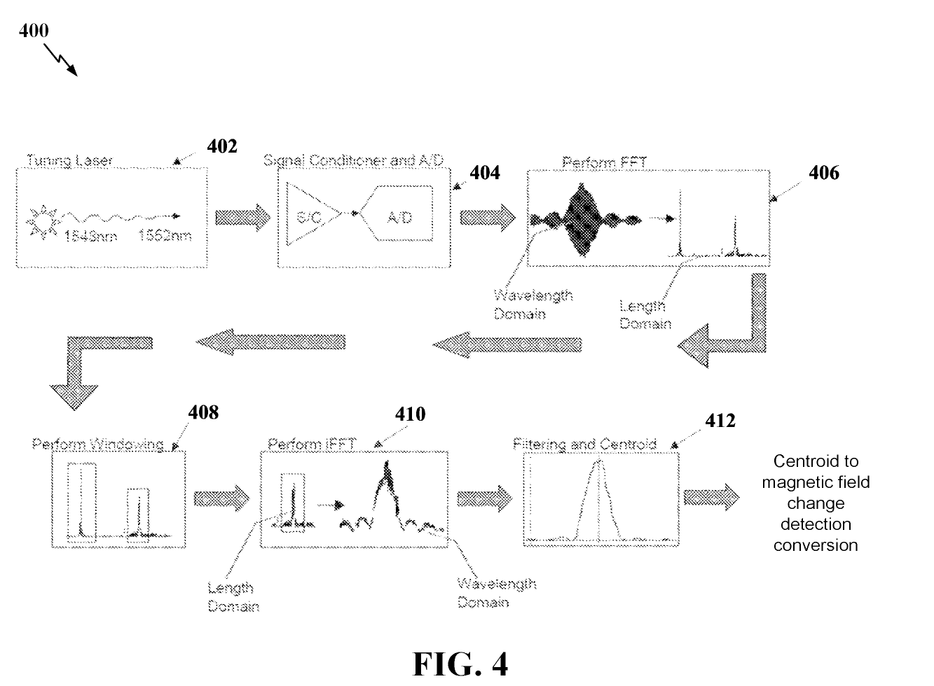

FIG. 4 illustrates one example of a block diagram 400 of various processes and modules that may be utilized to introduce and process an optical signal in the fiber optic system (e.g. 102 in FIGS. 1-3). In block 402, a tunable laser or photo diode input to the fiber (e.g., 102) is provided. In one example, the tuning laser (photo diode output) shown in block 402 can be tuned to a 1548-1552 nanometer range but is merely exemplary and is not limited to such as other wavelength ranges could be used. In a further example, the light output of the tuning laser 402 may input into a signal conditioner and analog-to-digital converter (A/D or ADC), as shown in block 404. A Fast Fourier Transform (FFT) can be performed on the ADC output, which is initially or input in the frequency or “wavelength” domain, and then subsequently converted by the FFT to the temporal or spatial (e.g., length) domain, as shown by the processes of block 406. As shown in block 406, the resulting FFT in the spatial or “length” domain will result in some peaks in wavelengths (frequencies) of interest. In aspects, the processes of block 402, 404, and 406 may be performed prior to introduction of the optical signal into the fiber 102.

After the optical signal from FFT 406 is propagated or transmitted through the fiber 102, at the output of the fiber, the optical signal may then be analyzed to determine changes in optical signals. In one example, the wavelength peaks produced by FFT 406 can be windowed in a manner known in the art to further process and isolate the output signal as shown in block 408. An inverse FFT (IFFT) can then be performed on the resulting windows 408 to convert the signal back to the frequency or wavelength domain, as can be shown by block 410. In further aspects, the windowed wavelength of interest can now be isolated, filtered, and centered as shown at block 412. In still further aspects, this filtered and centroid signal can be analyzed (and “converted”) to detect or sense magnetic field changes, which can then further be correlated to corrosion of the material under test/observation.

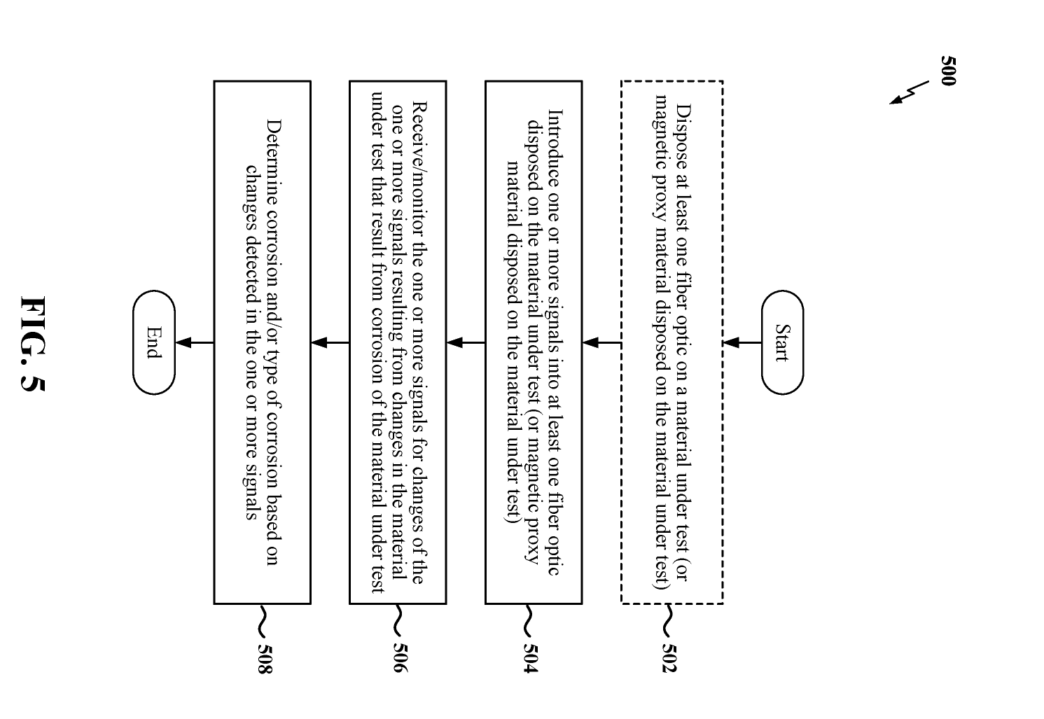

FIG. 5 illustrates a flow chart of an exemplary method 500 for detection of corrosion according to certain aspects of the present disclosure. As illustrated, method 500 includes an alternative process of first disposing at least one fiber optic on a material under test or on a magnetic proxy material disposed on the material under test as shown in block 502. It is noted that those skilled in the art will appreciate that method 500 may be practiced without process 502 if it is assumed that the fiber optic is pre-disposed on the material under test (or magnetic proxy material disposed on the material under test). Next, method 500 includes introducing one or more signals into the fiber optic disposed on either the material under test or the magnetic proxy material as shown at block 504. At the output end of the fiber optic, the one or more signals may then be received and/or monitored for changes of the one or more signals resulting from changes in magnetic fields in the material under test (or proxy material) that result from corrosion of the material under test, for example, as shown in block 506. Finally, method 500 includes processes in block 508 of determining corrosion and/or a type of corrosion based on detected changes of the one or more signals detected in block 506.

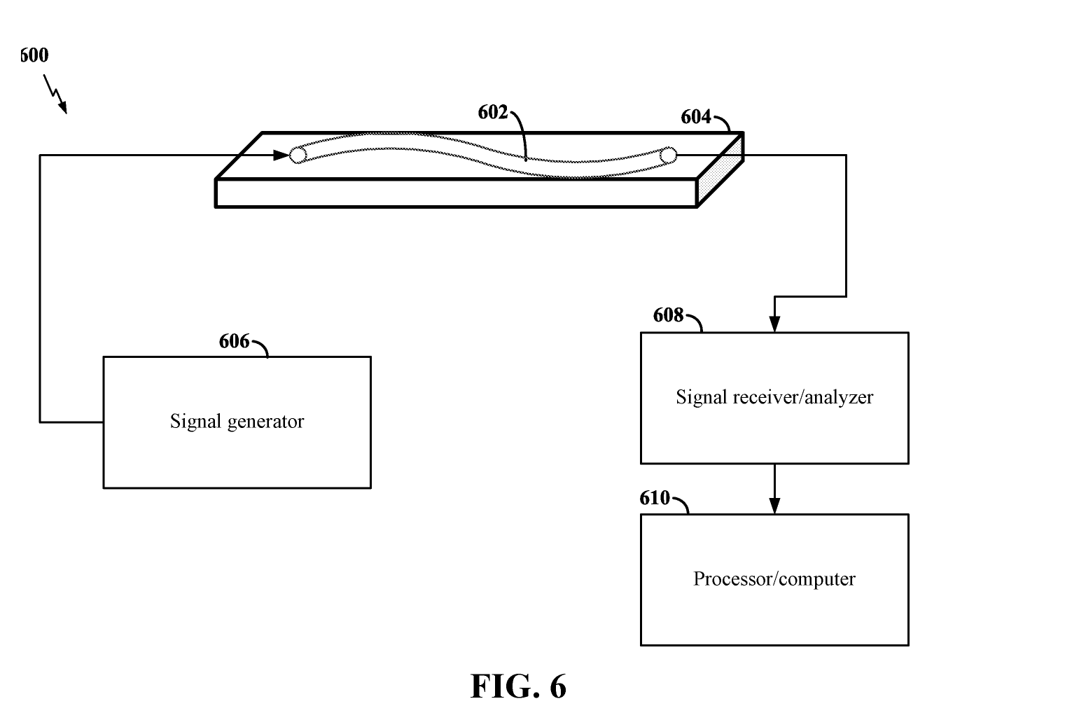

FIG. 6 illustrates a diagram of a system setup 600 for detection of corrosion according to certain aspects of the present disclosure. The setup 600 includes a fiber optic cable or line 602 disposed on a material under test 604. As discussed before, the material 604 may possess inherent magnetic fields such as with ferromagnetic materials or may include a magnetic material proxy substrate (not shown) disposed between the material 604 and the fiber 602. Also, in other aspects, an external source of a magnetic field (not shown) may be included to introduce such magnetic field to the material 604.

The setup 600 further includes a signal generator 606, such as an optical signal generator as one example, where the generator 606 is configured to introduce one or more signals into the fiber optic cable 602 such as was discussed in the previous example of FIG. 4. The setup 600 further includes a signal receiver/analyzer 608 configured to receive the one or more signals after transmission through the fiber optic cable. In other aspects, the signal receiver/analyzer 608 may be configured to determine changes in the one or more signals occurring due to magnetic field changes in the material resulting from corrosion of the material. In a particular aspect, this change in the magnetic field displaces or causes a change in the physical location of the fiber 602, which may be doped or coated with magnetic materials, and this change, in turn, affects the signals which are then correlated to degradation of the material 604.

In further aspects, it is noted that signal generator 606 and the signal receiver/analyzer 608 may be contained with a single unit or separate as illustrated in FIG. 6. Moreover, the setup 600 may include at least one processor or computer 610 communicatively coupled to the signal receiver/analyzer 608. The processor/computer 610 may be configured to determine one or more characteristics of corrosion and/or a type of corrosion of the material based on the determined changes in the one or more signals as detected/determined by the signal receiver/analyzer 608.

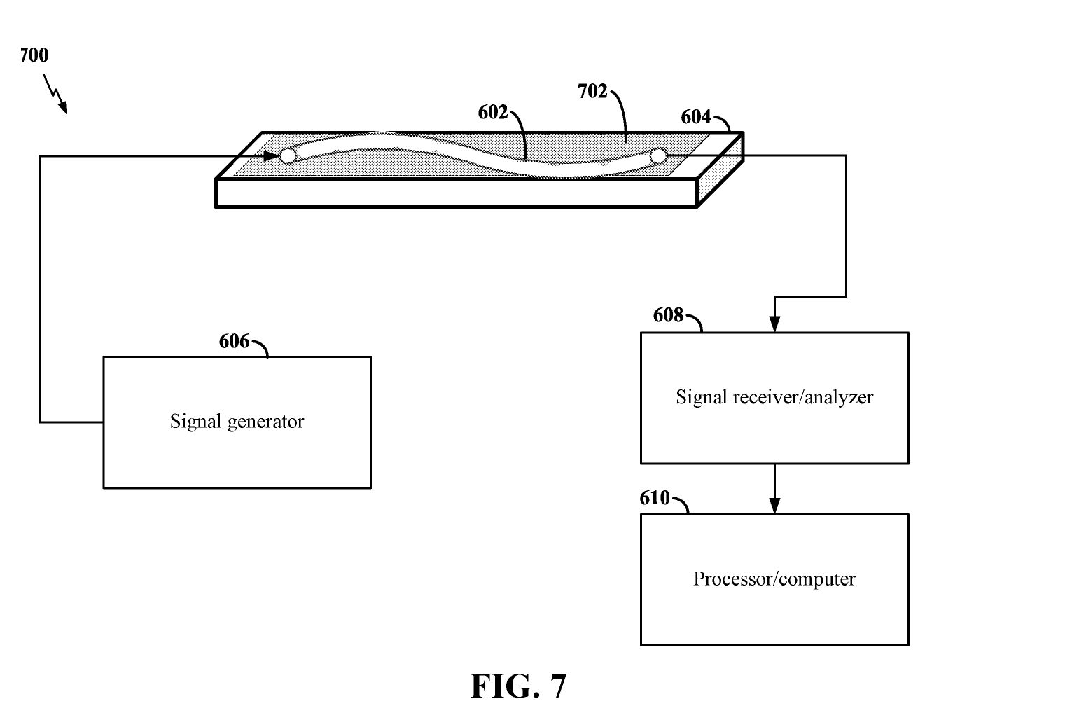

FIG. 7 illustrates a diagram of another corrosion detection system setup 700 for detection of corrosion according to certain aspects of the present disclosure. The setup 700 includes the same elements as discussed in FIG. 6, as well as an additional magnetic proxy substrate or material 702 (shown gray shaded). As illustrated, the magnetic material proxy or substrate 702 is disposed between the material 604 and the fiber 602 and may be used as proxy or substitute to detect corrosion of the material 604, such as in cases where the material 604 is non-magnetic as an example, but the use of the proxy 702 is not limited only to such applications.

As will be appreciated by those skilled in the art, the presently disclosed methods and apparatus will improve part life/cost by maximizing safe and reliable usage of loaded components and structures by continuously monitoring loads and the occurrence of material deterioration. Additionally, maintenance and costs associated therewith may be improved by minimizing unnecessary paint removal, disassembly, operator dependent NDI/E inspections and other unscheduled maintenance activities by reliably locating, sizing and tracking damage evolution via in-situ sensors (e.g., the overlaid fiber optic) and scheduling maintenance in a timely and cost effective manner. Still further, the presently disclosed methods and apparatus may be beneficial for the use of new materials; namely the presently disclosed methods and apparatus may be able to increase or maximize confidence in early adoption of new or optimized materials and structures by incorporating a minimalistic, yet sensitive and reliable, distributed sensor of networks.

Further advantages of the presently disclosed apparatus and methods as compared to other known types of sensor systems may include: (1) a smaller footprint: (out of sight, out of mind); (2) a smaller size and weight footprint, wherein the provided lighter systems are more survivable to impulsive or fatigue loading and/or can be placed closer to “hot spots”; (3) a better maintenance footprint that is corrosion resistant, self-calibrating, and/or self-diagnosing; (4) lower power requirement footprint through the use of lower power electronics/photonics; (5) an improved logistical footprint, such as developing a family of sensors (Temp, Strain, Impact, Humidity, TOW, AE) based in a common technology; (6) overall lower cost; (7) improved reliability that provides the right information (detection, localization, quantification) over the entire operational life of the platform (i.e., the material(s) used in a platform); (8) a larger spatial resolution compared to the known prior art base corrosion detection on strain which was limited to only detecting damage at exact fiber optic sites; and (9) a more deterministic of type of attack because only specific types of corrosion affect magnetism, which can be used to engender a more accurate understanding of the corrosion and types of corrosion occurring.

In further aspects, the present system and methods may be used to generate a library of magnetism characteristics for various chemical compositions with various types of corrosion. This library then can be used for correlation of what type of corrosion exists based on the magnetic characteristics detected by used of the fiber optic, or other means of detecting the magnetic field apart from the fiber optic system disclosed herein.

Although the presently disclosed apparatus and methods have been described in detail with reference to certain preferred examples or embodiments, variations and modifications exist within the spirit and scope of the present disclosure as and defined in the following claims.

What is claimed is:

1. An apparatus for corrosion detection of a material comprising:
at least one fiber optic cable disposed on or near the material;
a signal generator coupled to the at least one fiber optic cable and configured to introduce one or more signals into the fiber optic cable; and
a signal receiver/analyzer configured to receive the one or more signals after transmission through the fiber optic cable and determine changes in the one or more signals occurring due to magnetic field changes in the material as a result of corrosion of the material.

2. The apparatus of claim 1, further comprising:
at least one processor configured to determine one or more characteristics of corrosion and/or a type of corrosion of the material based on the determined changes in the one or more signals.

3. The apparatus of claim 1, further comprising:
the at least one fiber optic cable including a magnetic material disposed on or within the at least one fiber optic cable.

4. The apparatus of claim 1, further comprising:
the at least one fiber optic cable doped with a magnetic material located at least one of inside the at least one fiber optic cable and outside of the at least one fiber optic cable.

5. The apparatus of claim 1, wherein the at least one fiber optic cable includes one or more fiber Bragg gratings (FBGs).

6. An apparatus for corrosion detection of a material under test comprising:
a proxy substrate comprising a magnetic material, wherein the proxy substrate is disposed the material under test;
at least one fiber optic cable disposed on or near the proxy substrate;
a signal generator coupled to the at least one fiber optic cable and configured to introduce one or more signals into the fiber optic cable; and
a signal receiver/analyzer configured to receive the one or more signals after transmission through the at least one fiber optic cable and determine changes in the one or more signals occurring due to magnetic field changes in at least the proxy substrate as a result of corrosion of the material under test upon which the proxy substrate is disposed.

7. The apparatus of claim 6, wherein the material under test further comprises a non-magnetic material wherein corrosion or change of the proxy substrate may be used to detect and correlate corrosion of the non-magnetic material based on the at least one fiber optic cable disposed on the proxy substrate.

8. The apparatus of claim 6, wherein the at least one fiber optic cable is disposed on or in contact with both the proxy substrate and the material under test

9. The apparatus of claim 6, further comprising:
at least one processor configured to determine one or more characteristics of corrosion and/or a type of corrosion of the material based on the determined changes in the one or more signals.

10. The apparatus of claim 6, further comprising:
the at least one fiber optic cable including a magnetic material disposed on or within the at least one fiber optic cable.

11. The apparatus of claim 6, further comprising:
the at least one fiber optic cable doped with a magnetic material located at least one of inside the at least one fiber optic cable and outside of the at least one fiber optic cable.

12. The apparatus of claim 6, wherein the at least one fiber optic cable includes one or more fiber Bragg gratings (FBGs).

13. A method for corrosion detection of a material under test comprising:
introducing one or more signals into a fiber optic cable disposed on the material under test;
receiving the one or more signals after transmission through the fiber optic cable; and
determining changes in the one or more signals occurring due to magnetic field changes in the material as a result of corrosion of the material correlating changes in the one or more signals resultant from magnetic field changes in the material.

14. The method of claim 13, further comprising:
determining one or more characteristics of corrosion and/or a type of corrosion of the material based on the determined changes in the one or more signals.

15. The method of claim 13, wherein the at least one fiber optic cable including a magnetic material disposed on or within the at least one fiber optic cable.

16. The method of claim 13, wherein the at least one fiber optic cable doped with a magnetic material located at least one of inside the at least one fiber optic cable and outside the at least one fiber optic cable.

17. The method of claim 13, wherein the at least one fiber optic cable includes one or more fiber Bragg gratings (FBGs).
